(19) United States
(12) Patent Application Publication
(10) Pub. No.: US 2016/0217964 A1
(43) Pub. Date: Jul. 28, 2016

(54) Efficiently Ionizing Atoms Based on Electron Excitation

(71) Applicant: Board of Regents, The University of Texas System, Austin, TX (US)

(72) Inventor: Mark G. Raizen, Austin, TX (US)

(73) Assignee: Board of Regents, The University of Texas System, Austin, TX (US)

(21) Appl. No.: 14/983,437

(22) Filed: Dec. 29, 2015

Related U.S. Application Data
(60) Provisional application No. 62/099,220, filed on Jan. 2, 2015.

(51) Int. Cl. H01J 27/26

(52) U.S. Cl. CPC H01J 27/26

(57) ABSTRACT

Systems and methods exposing a sample of atoms to an electromagnetic (EM) field. The EM includes one or more frequencies. The EM field is configured to promote at least a subset of the sample of atoms to one or more excited states based at least upon the one or more frequencies. The one or more excited states are low-lying, metastable states. Furthermore, the subset of the sample of atoms is ionized based at least upon the subset of the sample of atoms being at the one or more excited states.

### A. CROSS REFERENCE TO RELATED APPLICATIONS

This application claims the benefit under 35 U.S.C. §119(e) of U.S. Provisional Patent Application No. 62/099,220, filed on 2 Jan. 2015, titled “Isotope Separation by Photo-Enabled Electric-Field Ionization” and naming Mark G. Raizen as inventor. The aforementioned application is incorporated herein by reference in its entirety.

### B. TECHNICAL FIELD/BACKGROUND

The present disclosure relates in general to the efficient ionization of atoms based at least upon the excitation of electrons to higher states with electromagnetic (EM) fields. The efficient ionization of atoms is important in many science and engineering applications, such as mass spectrometry, radiation therapy, atom separation, etc.

### C. BRIEF DESCRIPTION OF THE DRAWINGS

Other objects and advantages may become apparent upon reading the detailed description and upon reference to the accompanying drawings.

The benefits, features, and advantages of the present disclosure will become better understood with regard to the following description, and accompanying drawings.

FIG. 1 illustrates a schematic of example stages in the ionization—and optional separation—of atoms, in accordance with some embodiments.

FIG. 2 illustrates a flow diagram of an example procedure for separating isotopes using field ionization, in accordance with some embodiments.

FIG. 3 illustrates a schematic of example stages in the ionization—and separation—of atoms using field ionization, in accordance with some embodiments.

FIG. 4 illustrates an example of an apparatus configured to ionize—and separate—atoms using field ionization, in accordance with some embodiments.

FIG. 5 illustrates an example of an apparatus configured to ionize—and separate—atoms using surface ionization, in accordance with some embodiments.

FIG. 6 illustrates a flow diagram of an example procedure for separating isotopes using surface ionization, in accordance with some embodiments.

While specific embodiments are shown by way of example in the drawings and the accompanying detailed description, various other modifications and alternative forms are possible. It should be understood that the drawings and detailed description are not intended to be limiting.

### D. DETAILED DESCRIPTION

The following detailed description is merely illustrative in nature and is not intended to limit the embodiments of the subject matter of the application or uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

This specification includes references to “some embodiments”, “one embodiment”, or “an embodiment.” The appearances of the phrases “in some embodiments”, “in one embodiment”, or “in an embodiment” do not necessarily refer to the same embodiment. Particular features, structures, or characteristics may be combined in any suitable manner consistent with this disclosure.

Terminology: The following paragraphs provide definitions and/or context for terms found in this disclosure (including the appended claims):

“Comprising”: This term is open-ended. As used in the appended claims, this term does not foreclose additional structures or steps.

“Configured To”: Various units or components may be described or claimed as “configured to” perform a task or tasks. In such contexts, “configured to” is used to connote structure by indicating that the units/components include structure that performs those task or tasks during operation. As such, the unit/component can be said to be configured to perform the task even when the specified unit/component is not currently operational (e.g., is not on/active). Reciting that a unit/circuit/component is “configured to” perform one or more tasks is expressly intended not to invoke 35 U.S.C. §112, sixth paragraph, for that unit/component.

“First”, “Second”, etc.: As used herein, these terms are used as labels for nouns that they precede, and do not imply any type of ordering (e.g., spatial, temporal, logical, etc.). For example, reference to a “first” module unit does not necessarily imply that this module unit is the first module unit in a sequence; instead, the term “first” is used to differentiate this module unit from another module unit (e.g., a “second” module unit).

“Based Upon/On”: As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

“Coupled”: The following description refers to elements, nodes, or features being “coupled”. As used herein, unless expressly stated otherwise, “coupled” means that one element/node/feature is directly or indirectly joined to (or directly or indirectly communicates with) another element/node/feature, and not necessarily mechanically.

“Inhibit”: As used herein, inhibit is used to describe a reducing or minimizing effect. When a component or feature is described as inhibiting an action, motion, or condition it may completely prevent the result/outcome or future state completely. Additionally, “inhibit” can also refer to a reduction or lessening of the outcome, performance, and/or effect that might otherwise occur. Accordingly, when a component, element, or feature is referred to as inhibiting a result or state, it need not completely prevent or eliminate the result or state.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference, which is made clear by reference to the text and the associated drawings describing the component under discussion. Such terminology may include the words specifically mentioned above, derivatives thereof, and words of similar import.

In the following description, numerous specific details are set forth, such as specific operations, in order to provide a thorough understanding of embodiments of the present disclosure. It will be apparent to one skilled in the art that embodiments of the present disclosure may be practiced without these specific details. In other instances, well-known techniques are not described in detail in order to not obscure embodiments of the present disclosure.

In one aspect a method of separating isotopes is featured. In some embodiments, the method includes applying an optical-pumping field to a multi-isotope sample, where the optical pumping field is selective for a first subset of isotopic components in the multi isotope sample. After application of the optical-pumping field, an ionizing electric field is applied to the multi-isotope sample.

In another aspect, a system includes an illumination source configured to apply an optical pumping field to a multi-isotope sample. The optical-pumping field is selective for a first subset of isotopic components in the multi isotope sample. The system also includes a field ionization unit. Based on the selective optical-pumping and ionization, the system is useful to separate selected isotopes or to tailor isotopic mixtures from natural isotopic mixtures of an element, or from mixtures of multiple elements.

Stable isotopes are used in many fields either directly or as precursors to radioisotopes. In medicine, isotopes, including radioisotopes, are used for diagnostic imaging, therapies, palliation, and research. In Industry, isotopes are used in the production of energy, in fluorescent and UV lighting, in materials inspections, and as standards for various testing and monitoring procedures. Isotopes are useful in a broad range of basic research in physics, astronomy, environment, agriculture, materials, geosciences and analytical chemistry. Isotopes are critical to applications such as GPS timing, atomic clocks, radiation detection, explosives detection, communications, and collection of nuclear data.

Similarly, cost-effective and efficient ionization of atoms and molecules could be useful for various processes and industries, including but not limited to oil and gas, defense, aerospace, and industrial processing.

In one respect, disclosed is a method for exposing a sample of atoms to an electromagnetic (EM) field, including one or more frequencies. The EM field is configured to promote at least a subset of the sample of atoms to one or more excited states based at least upon the one or more frequencies. In some applications, the one or more excited states are low-lying, metastable states. Furthermore, the subset of the sample of atoms is ionized based at least upon the subset of the sample of the atoms being at the one or more excited states.

In another respect, disclosed is a system including an electromagnetic (EM) field source configured to generate an EM field and to expose, to the EM field, a sample of atoms, where the EM field comprises one or more frequencies, where the EM field is configured to promote at least a subset of the sample of atoms to one or more excited states based at least upon the one or more frequencies, where the one or more excited states are low-lying, metastable states. The system also includes an ionizer configured to ionize the subset of the sample of atoms based at least upon the subset of the sample of the atoms being at the one or more excited states.

In yet another respect, disclosed is a system including an electromagnetic (EM) field source configured to generate an EM field and to expose, to the EM field, two or more isotopes, where the EM field comprises one or more frequencies, where the EM field is configured to promote at least one of the isotopes to one or more excited states based at least upon the one or more frequencies, where the one or more excited states are low-lying, metastable states. The system also includes an ionizer configured to ionize the at least one isotopes based at least upon the at least one of the isotopes being at the one or more excited states.

One aspect of the invention features a method of bulk ionization of atoms by optically exciting the atoms to a low-lying metastable state and exposing the excited atoms to an electric field to ionize the excited atoms.

In yet another aspect, disclosed is a method that affords selective ionization of excited atoms, such as selected isotopes in contrast to systems that ionize substantially all atoms. Selective ionization allows for high-efficiency separation of atoms or molecules from a bulk sample.

Most elements, with the exception of alkalis, have a high ionization energy and hence are not amenable directly to ionization. However, using a laser or other EM field, elements can be promoted to a metastable state that is within the work function of many metals, and therefore amenable to ionization.

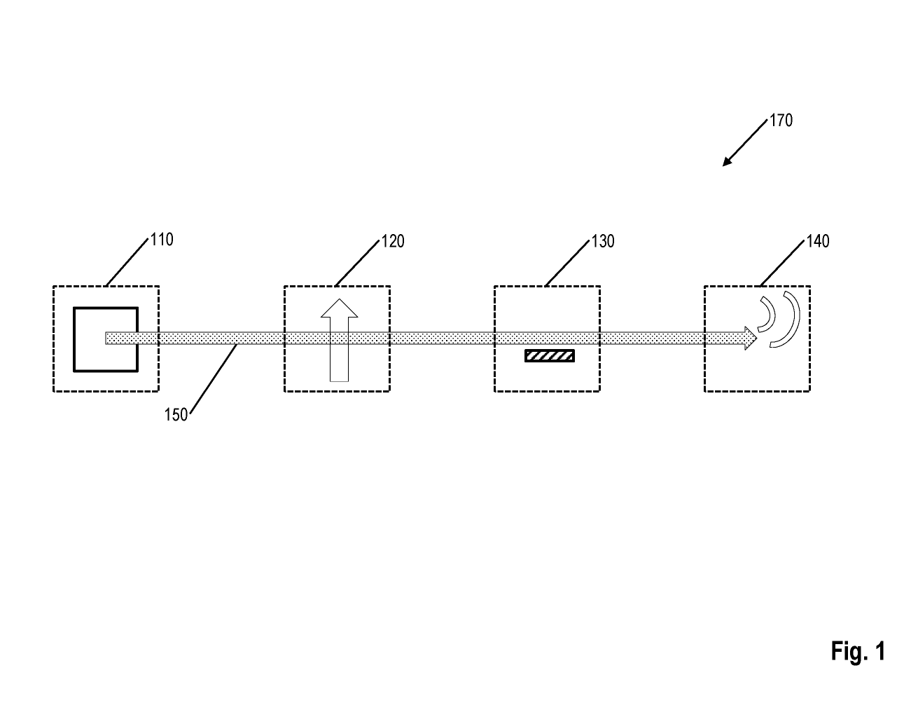

FIG. 1 illustrates a schematic of example stages in the ionization—and optional separation—of atoms, in accordance with some embodiments.

Apparatus 170 includes various stages through which atoms may be efficiently ionized and processed. In some embodiments, at least some of the stages may be placed within a vacuum chamber.

At stage 110, sample of atoms 150 may be sourced and may be given some initial kinetic energy. In some embodiments, stage 110 may include an oven. The oven may be heated to a certain temperature, and the atoms may leave the oven through an opening in the oven to form an atomic beam and move toward the next processing stage having acquired a certain amount of kinetic energy. In some embodiments, the temperature may be sufficiently high to impart significant kinetic energy to the atoms in the atomic beam. For example, in some embodiments, the atoms in the atomic beam may be moving meters per millisecond. This kinetic energy and electric fields can be used to spatially separate atoms based on transient excited states that may only last a small fraction of second.

In some embodiments, the apparatus described here is amenable to operating at lower temperatures and is configured to yield lower kinetic energy values for lighter atoms and/or molecules. In addition, it may be easier to evaporate lighter elements and to keep the ionizing material surface clean, as will be discussed in more detail below.

At stage 120, sample of atoms 150 is exposed to an EM field. In some embodiments, the EM field may have peaks that are centered around one or more frequencies. The frequencies may be chosen to match one or more energy gaps for at least a subset of the atoms in the sample.

Accordingly, the EM field may be designed to excite electrons, for at least a subset of the atoms, to a metastable state. In some embodiments, the metastable state may be reached by two or more electron transitions by interaction with two or more corresponding EM field frequencies. Generally, a metastable state is a state with a decay time (the time that it takes for the electron to transition to a lower energy state) that is long enough for the atom to be processed through the ionization state.

In various contexts, a metastable state of an atom is an electronic state with an energy higher than the ground state, but with a relatively long lifetime before spontaneous decay is expected to return the atom to a lower energy state. For example, the 1/e lifetime of a metastable state may be on the order of 10⁻⁵ to 10⁻² seconds or longer. Metastable states may generally arise because spontaneous decay from these states is relatively improbable. In some cases, this improbability may be due to quantum mechanical dipole selection rules, for example.

In some embodiments, the electron transitions may be limited to low-lying energy levels, which may be defined as energy levels with a principal quantum number that is less than about five (n=1, 2, 3, 4, or 5). In some embodiments, more complicated pulsed laser schemes with multiple frequencies and high intensity may be needed to excite atoms at much higher energy levels. Accordingly, such methods may not be as scalable to exciting atom quantities to higher energy levels as high power lasers may be required.

In some embodiments, the EM field may be designed to interact with only a subset of the sample of atoms. In some cases, for example, the sample of atoms may consist of two or more types of atoms, such as two or more different isotopes of an element, or of two or more different elements or molecules. As such, the EM field may be designed to interact with and excite electrons of a particular selected type of atom only (for example, a particular isotope only). Accordingly, as will be discussed below, only those selected types of atoms (or isotopes or molecules) may be ionized at the next stages. The sample of atoms may then be divided into two or more groups based at least upon the ionization of only one group of atoms.

The process of isotope separation is a challenging but important task. Many elements can be found in nature, but only as a natural mix or a combination of multiple isotopes. All isotopes of a given element have the same basic physical and chemical properties. However, various manufacturing, scientific, or medical applications require substantially pure sample of a single isotope. In some situations, it may also be helpful to have a particular mixture of two or more isotopes in different ratios than the naturally occurring ratios. For example, mercury (element Hg) is naturally found as a mixture of seven isotopes (e.g., with molar ratios of 0.15% 196Hg, 9.97% 198Hg, 16.87% 199Hg, 23.10% 200Hg, 13.18% 201Hg, 29.86% 202Hg, and 6.87% 204Hg). Samples of mercury with modified or tailored isotopic distributions may be useful, for example, in greatly improving the efficiency of fluorescent or UV lighting.

Similarly, thallium (element Tl) is naturally found as a mixture of two isotopes (e.g., with molar ratios of 29.5% 203Tl and 70.5% 205Tl). The minority isotope, 203Tl, may be of interest since it can be transmuted to the radioisotope 201Tl, which has applications in medical diagnostics. Still other isotopes find application in diagnostic imaging (SPECT or PET), medical therapies (brachytherapy, beta-therapy, and alpha-therapy), and in metabolic research or other medical research.

Many medical radioisotopes are derived from stable precursor isotopes that are then placed in cyclotrons, accelerators and reactors. Positron emission tomography (PET) detects pairs of gamma rays emitted indirectly by a positron-emitting radionuclide (tracer) to produces a three-dimensional image of functional processes in the body. F-18 is the most frequently used PET tracer, however, a variety of isotopes are needed to address all of the different imaging needs since different isotopes and compounds target different tissues.

Single photon emission computed tomography (SPECT) is similar to PET in its use of radioactive tracers, however, the tracers used in SPECT emit gamma radiation that is measured directly, whereas PET tracer emits positrons that annihilate with electrons causing two gamma photons to be emitted in opposite directions. SPECT scans are less expensive than PET scans, in part because they use longer-lived radioisotopes, e.g., Tc-99m, Tl-201, In-111. Still other radioisotopes of hydrogen, carbon, phosphorus, sulphur, and iodine have been used extensively to trace the path of biochemical reactions.

Another example of isotope separation involves the separation of isotopes that are part of molecular compounds, such separating molecules of CO₂ with carbon-13, or separating molecules of H₂O with oxygen-18. Isotope O-18 may be used, for example, to produce F-18 in a medical cyclotron. Isotope F-18 is widely used in PET scans, for example.

The natural abundance of O-18 is approximately 0.2%, or one out of every 500 water molecules is composed of this O-18 as opposed to O-16. Current separation technologies for O-18 rely on expensive, toxic, and/or flammable processes. As described here, water vapor may be ionized efficiently and collected. Prior to ionization, H₂O molecules with O-18 would be vibrationally excited with a near-infra-red laser, for example. An anti-symmetric stretch mode can be excited at a wavelength of 2662 nm, for example, to preferentially ionize the desired isotopes. Though the energy gap is small between the ground state and the vibrationally excited state, the process may be repeated in multiple stages in order to increase the enrichment factor. In some embodiments, enriched H₂O in O-17 may be produced (natural abundance of 0.038%), which may be used as a tracer and with NMR experiments for lung imaging, for example.

Generally, in cases where the atom is part of a molecule, an appropriately designed EM field with appropriate frequencies may be used to excite the appropriate isotope(s). In the case of molecular CO₂, a Quantum Cascade Laser having approximately a 4-micrometer wavelength may be used to excite a vibrational mode. The laser may be tuned to excite only CO₂ molecules with carbon-13 and not ones with carbon-12, for example, as the vibrational line of CO₂ with C-13 is distinct from CO₂ with C-12.

Historically, a variety of techniques has been used for separating or purifying isotopes. Some examples are noted in U.S. Pat. No. 8,672,138 titled “Isotope Separation by Magnetic Activation and Separation,” which is hereby incorporated by reference herein, in its entirety and for all purposes. See also, “Demonstration of magnetically activated and guided isotope separation,” Thomas R. Mazur, Bruce Klappauf, and Mark G. Raizen, Nature Physics 10, 601-605 (2014), which is also incorporated herein by reference in its entirety and for all purposes.

In various implementations, a method for isotope separation may involve at least three phases: illumination by an EM field, ionization, and spatial separation. In the illumination phase (such as stage 120), the sample of atoms is illuminated by an EM source. The EM source (for example, a lamp, light emitting diode (LED), and/or laser) is used to selectively excite or promote or “optically pump” ground state atoms of one or more isotopes into a low-lying, metastable state.

For many elements, different isotopes have slightly different absorption spectra: the energy levels of their absorption lines are slightly shifted from one isotope to another. Because of this isotope shift, an appropriately tuned EM source (such as light) can selectively promote atoms of one or more particular targeted isotopes into a metastable state, while the other atoms remain in the ground state.

The electrons of the excited atoms are then at higher energy levels compared to the outer electrons of the atoms that have not been excited. Accordingly, excited atoms have ionization energies that are lower compared to the ionization energies of atoms that have not been excited. Thus, atoms with electrons that are excited to higher energy levels are much more susceptible to ionization. At stage 130, the sample of atoms (both excited and not excited) is subjected to one or more types of ionization processes. Various ionization methods may be used, such as field ionization, surface ionization, etc. as will be described in more detail below. It should also be noted that, in some embodiments, a combination of two or more ionization methods may be used, either concurrently or sequentially.

In some embodiments, the physical distance between stage 120 and stage 130 and the time of flight may be adjusted such that the atoms that were excited to the metastable state remain in the metastable state long enough to reach and be processed through state 130. Factors such as the kinetic energy of the atoms, mean atom beam velocity, the decay time from the metastable state, and the distance between stages 120 and 130 may be considered and adjusted to ensure that the atoms in the metastable state reach and are processed through the ionizing stage before decaying from the metastable state.

In some embodiments, field ionization may be used as one of the ionization processes at stage 130. Field ionization involves exposing the atoms to a high-magnitude electric field. The high electric field may be switched on around the location of the atoms, or the atoms may be transmitted through the high electric field. In various implementations, the electric field is of an appropriately high magnitude to cause field ionization of the metastable atoms without ionizing the electrically neutral atoms.

One approach to creating a sufficiently high field is to use one or more geometric sharp tips that are held at a high voltage. The geometry of the sharp tips causes a high electric field near the tips because of their small radius of curvature. In various implementations, a field-ionization region can be created using a two-dimensional array of tips fabricated on a substrate. The tips can be spaced sufficiently far from each other to allow a large potential gradient (electric field) between neighboring tips. This arrangement can be used to create a region in which there are multiple volumes where field ionization can occur (e.g., one high-field volume near each tip). The sample of atoms may be transmitted through this region. In various applications, as atoms approach the tips, the atoms are attracted by the electric field, for example, due to inducement of dipole moments in the atoms. The metastable atoms are ionized when the atoms are close enough to the tips that the electric field is sufficiently strong to cause field ionization of the atoms. The interaction can be modeled, for example, using simulations of the quantum-mechanical interactions between the fields and the atoms. The spacing, geometries, and applied voltages on the tips may be optimized for efficient ionization. The optimization may be based on simulations, experimental trials, or combinations thereof. When the sample emerges from the field-ionization region, at least a fraction of the previously excited atoms (corresponding to the one or more targeted isotopes) will be ionized. With appropriately chosen tip geometries, array geometries, and tip potentials, the previously non-excited atoms are unlikely to be ionized in traversing the field-ionization region.

Recent advances in nano-science offer improved methods for producing ultra-sharp tips of carbon nanotubes, and other methods have also improved techniques for fabricating arrays of field emitters. (See, e.g., “Growth of CNTs emitter with resist-assisted patterning process,” presentation by Kyu Chang Park (Aug. 12, 2014) [Park-2014], which is hereby incorporated by reference herein, in its entirety and for all purposes; “Carbon Nanotube Electron Emitter for X-ray Imaging,” Je Hwang Ryu, Jung Su Kang and Kyu Chang Park, Materials 2012, 5, 2353-2359 (2012) [Park-2012], which is hereby incorporated by reference herein, in its entirety and for all purposes.)

In some embodiments, large-scale ordered nanowire arrays may be used as the source of the high electric fields. The manufacturing of such nanowire arrays is described, for example, in “Knocking Down Highly-Ordered Large-Scale Nanowire Arrays” by Alexander Pevzner, Yoni Engel, Roey Elnathan, Tamir Ducobni, Moshit Ben-Ishai, Koteeswara Reddy, Nava Shpaisman, Alexander Tsukernik, Mark Oksman, and Fernando Patolsky, School of Chemistry, Nanoscale Science Center, and Faculty of Engineering, Tel-Aviv University, Tel Aviv 69978, Israel, Nano Letters 2010, Vol. 10, pages 1202-1208, which is hereby incorporated by reference herein, in its entirety and for all purposes.

Various other methods for fabricating sharp tips on surfaces with resolution of nanometers may be used. Such methods include electron beam and ion-beam lithography and Jet-Flash imprint lithography. Various materials may be used in the fabrication of the tips, such as doped semiconductors or metals. In some embodiments, the sharp features may be capped with metallic coating and may also incorporate insulating layers. The optimum method, composition, and geometry may be determined by and adapted to each specific application.

In various applications, an array of tips may be biased at negative voltage, for example, to emit electrons through field emission. Alternatively, an array of tips may be biased at positive voltage, for example to induce field ionization of atoms. In various implementations of a field ionization procedure, a tip voltage is held constant (e.g., a “DC” voltage); in other implementations, the voltage is a time-varying voltage such as a rising voltage, a decaying voltage, a stepped voltage, or a sinusoidal voltage (e.g., an “AC” voltage). In various implementations, field-ionizing tips may be maintained at a temperature that is sufficiently high to prevent non-ionized atoms from sticking to the tips. In some applications (e.g., for separating mercury atoms), this temperature may be relatively moderate. For other applications (e.g., for separating atoms or molecules with higher melting or vaporization temperatures), the temperature may be substantially higher (e.g., 1000 degrees C. or more). In various applications, an appropriate temperature for the tips may be estimated by considering the temperature needed to maintain a substantial vapor pressure of the atoms.

At the conclusion of the ionization phase, some of the atoms in the sample have been ionized by the high electric field, and some have not. With an appropriately selected intensity and duration, the high electric field (e.g., 10⁷ V/cm to 10⁹ V/cm for several microseconds to several seconds) may ionize many or most of the atoms that were previously promoted to the metastable state, while leaving most or all of the unpromoted atoms electrically neutral.

In some embodiments, surface ionization may be used as another of the ionization processes at stage 130. Generally, atoms that are in close proximity to the surface of an ionizing material can be ionized if the ionization energy of the atom is less than the work function of the ionizing material. In some embodiments, various types of metals may be used as an ionizing material.

In some embodiments, an ionizing material (such as a metal) may be chosen based at least upon the work function of that ionizing material. For example, a desirable value for the work function may be one that is less than the atom's ground state ionization energy and greater than the ionization energy of the atom at the excited state. As such, in the proximity of the ionizing material, there would be a high probability that the atoms in the ground state do not become ionized, while the atoms in the excited do become ionized.

In some embodiments, in order to inhibit/prevent the ionized atoms from sticking to the surface of the ionizing material and neutralizing (a process sometimes referred to as Auger neutralization), the ionizing material may be biased with a high positive voltage or the ionizing material may be heated to a high temperature. In some embodiments, the ionizing material may be kept simultaneously at a high voltage and at a high temperature. In some embodiments, the atoms may be displaced before the atom can receive an electron from the ionizing material and neutralize.

In some embodiments, the surface of the ionizing material may be rough to provide additional field enhancement and to encourage ionization and/or to further inhibit neutralization of the ionized atom.

After ionization, stage 140 involves spatially separating the ionized atoms from the neutral atoms—and optionally collecting the ionized and electrically neutral atoms at different locations. In various implementations, this spatial separation can be accomplished by applying an electric field to accelerate the ions (while not affecting the electrically neutral atoms). In many situations, this field may be substantially uniform in direction and may be applied between two plates by applying an electric potential between the plates.

In some embodiments, the electric field is configured to separate the ions from the stream of neutral atoms and move them to a collector region that does not have a line-of-sight to the ionization stage. The electric field may be configured to bend the ion trajectories (for example, by an angle of 90 degrees) and guide the ions to a separate region of the vacuum chamber where the ions may be collected.

After being spatially separated, the ions may be collected in one location and the neutral atoms may be collected in another. It should be noted that, in embodiments where isotopes of an atom are being sorted, the two collections—ions and neutral atoms—will be isotopically different. The collected ions will all or mostly be the result of the atoms that were ionized in the ionizing stage, which were all or mostly the atoms promoted to metastable states in the EM field stage, which were all or mostly atoms of the targeted isotope(s). In contrast, the collected neutral atoms will all or mostly be the result of the atoms that were not ionized in the ionizing stage, which were all or mostly the atoms not promoted to metastable states in the EM field stage, which were all or mostly atoms not of the targeted isotope(s).

Such approaches to isotope separation may be particularly useful for elements with electromagnetic spectra including long-lived metastable states and that have isotopic shifts that cleanly separate the relevant absorption lines, of transitions leading to those metastable states, for two or more isotopes. A variety of elements may be amenable to isotopic separation through selective excitation followed by ionization. Some candidates are mercury, ytterbium, thallium, various alkaline earth elements, and other elements. A variety of excitation sources may be used, depending on the nature of the excitation that is required. For example, an excitation source may include an optical source such as a discharge lamp, a laser, an LED, or other type of light source, or combinations thereof. In various applications, other wavelengths of electromagnetic radiation may instead, or in addition, be used for pumping to a metastable state (e.g., radio frequency, microwave, x-ray, gamma ray, etc.).

In various examples of a separation process for mercury isotopes, an excitation source is a mercury discharge lamp. The discharge lamp may contain a single isotope of mercury (e.g., an isotope that matches an isotope being selected for excitation) or an optimized isotopic mixture. For example, the discharge lamp may be used to generate light at wavelengths of approximately 253.7 nm and 435.8 nm. Absorption of photons at these two wavelengths could excite a mercury atom from a ground state into a state from which it may decay into long-lived triplet P states. For example, absorption of a 253.7 nm photon may take a mercury atom from the 6s2 1S0 ground state to the 6s6p 3P1 state; absorption of a 435.8 nm photon may then take the atom to the 6s7s 3S1 state; spontaneous emission may then take the atom to a 6s6p 3P2 metastable state or a 6s6p 3P0 metastable state, from which spontaneous emission to the ground state is largely forbidden by dipole selection rules. If the isotopics of the source light are tailored so that the emitted wavelengths are specific to one or more selected mercury isotopes, then only atoms of the selected isotopes will be driven into the metastable states.

In some applications, a tailored isotopic mixture of Hg can be used to produce a lamp, e.g., 254 nm lamp, that would produce a similar tailored isotopic mixture through selective degrees of excitation of the various isotopes of the sample corresponding to the isotopic mixtures used to produce the excitation lamp. In some cases, the separated stream may consist of a particular mixture of several isotopes, and not a single isotope. This may be desirable, for example, in the preparation of isotopically optimized Hg mixtures for lighting applications. A single-pass process can prepare a desired ratio of isotopes by tailoring the spectral power of the light source used for excitation.

Thus, such procedures may be useful, for example, to generate mercury samples with tailored isotopic proportions for improving efficiency in mercury lamps. (See, e.g., U.S. Pat. No. 8,975,810, titled “Compositions of mercury isotopes for lighting”; see also “Enhanced Escape Rate for Hg 254 nm Resonance Radiation in Fluorescent Lamps” published in J. Phys. D: Appl. Phys. 46 (2013), which are hereby incorporated by reference herein, in their entirety and for all purposes.) Similar procedures could be used for isotope separation in elements other than mercury.

As another example of isotopes that may be separable using selective pumping to a metastable state is thallium, which naturally occurs as a mixture of 203Tl and 205Tl. Thallium can be optically pumped from a ground 6P1/2 state to a 7S1/2 state, where it may decay with a branching ratio of 50% into a long-lived metastable 6P3/2 state. In this process, an atom absorbs a photon with a wavelength of approximately 378 nm, and emits a photon with a wavelength of approximately 535 nm.

In addition to providing isotopic separation starting from samples of atoms, this approach may also be applied to samples of molecules of containing those isotopes. In some cases, a desired isotope or molecule may be separated from among a mixture of different elements, for example in extracting an isotope from among the various elements produced within a target irradiated with a proton beam or neutron flux. Accordingly, aspects of the invention may be employed within a hot cell to address separation of radioisotopes, stable isotopes, and/or molecules from a mix of atoms including radioactive atoms.

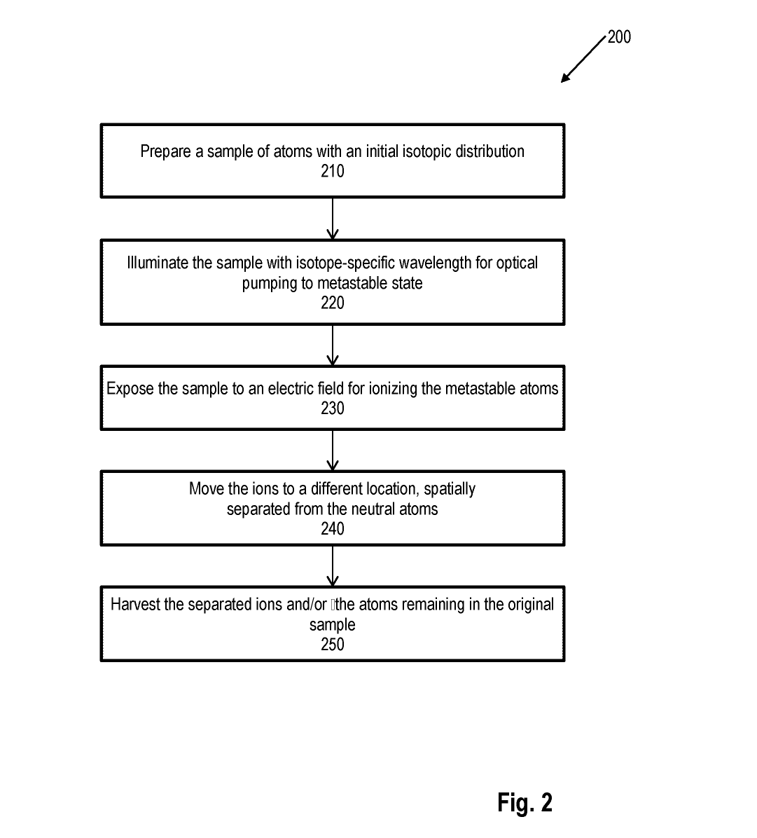

FIG. 2 illustrates a flow diagram of an example procedure for separating isotopes using field ionization, in accordance with some embodiments.

FIG. 2 shows an example procedure 200 for isotope-based separation. Procedure 200 may be used in various situations to separate a sample of atoms into two or more samples that have different isotopic compositions. In yet other situations, procedure 200 may be used for separating a sample of molecules into two or more samples with different isotopic compositions.

In act 210, an initial sample is prepared. This starting sample may be a naturally available or commercially available sample of atoms. In various circumstances, the initial sample is a substantially chemically pure sample, such as a sample of elemental mercury or elemental ytterbium. In other situations, the initial sample may have some contamination, or may be a mixture of atoms of different elements.

In yet other situations, the starting sample may be a naturally available or commercially available sample of molecules, such as a substantially pure compound, or a compound with some contamination, or may be a mixture of molecules and atoms.

The initial sample includes at least two components that are isotopically different, even though they may be chemically the same. For example, the sample may be a mixture of seven components that are the naturally-occurring isotopes of mercury: Hg-196, Hg-198, Hg-199, Hg-200, Hg-201, Hg-202, and Hg-204.

In various embodiments of the method, the initial sample is isolated in a vacuum chamber and vaporized. Depending on the implementation, the initial sample may be prepared as a thermal vapor, or may be optically trapped, magnetically trapped, or magneto-optically trapped, or may be projected in a vapor beam.

In act 220, the sample is illuminated with light. The light includes one or more wavelengths that are specifically chosen to distinguish among isotopic components in the sample. With this wavelength-based distinction, procedure 200 may be used to spatially separate a first group of isotopic components in the initial sample from a second group of isotopic components in the initial sample.

The wavelength(s) of the illumination are chosen so that the first group of one or more isotopic components has a high probability of absorbing the light in act 220 and being promoted to a metastable state. The second group, with the remaining isotopic components, has a low probability of absorbing the light or a low probability of being promoted by the light to a metastable state in act 220. In various approaches, the light in act 220 may be generated by one or more lasers with bandwidths less than the linewidth of the relevant absorption spectra, and specifically tuned to transitions for one or more isotopes while being off-frequency for the corresponding transitions in other isotopes.

In one example, the initial sample consists of the seven isotopes of mercury. The first group of isotopic components is Hg-196 atoms. The other mercury atoms are considered to be in the second group.

The first group of components (Hg-196 atoms, in this example) is to be separated from the second group of components (Hg-198, Hg-199, Hg-200, Hg-201, Hg-202, and Hg-204 atoms, in this example). For this example, the illuminating light in act 220 includes light from two sources. A first source of the light is specifically tuned to a 253.7 nm transition that is selective for Hg-196. An example of isotope-selective tunings can be seen from the spectra that are described in U.S. Pat. No. 8,975,810, noted above, for example in FIG. 2 and the associated discussions, which are incorporated by reference herein.

The linewidth of lasers typically used for optical pumping (˜ few MHz) is substantially narrower than the isotopic features of this transition in mercury (approximately 1-2 GHz wide in optical frequency), and the absorption peak of this transition for Hg-196 is cleanly resolved from the absorption peaks of other mercury isotopes.

In addition, the atomic beam divergence in the transverse direction (the direction perpendicular to the direction of the atom beam and parallel to the EM field, in some embodiments) may be limited such that the Doppler width of the atoms in that direction is substantially less than the isotope shift. As such, only the desired isotope may be excited to a metastable state.

The other isotopes would be substantially transparent to this light, since their spectral line wings are vanishingly small at these two transition frequencies. A second source of the light in act 220 is tuned to the 435.8 nm transition for Hg-196. The light from these two sources may cause a substantial portion of the Hg-196 atoms in the sample (the first group of components in this example) to be promoted into a 6s6p 3P2 or 6s6p 3P0 metastable state, while atoms of the six other mercury isotopes (the second group of components in this example) would largely remain in the ground state. Any combination of light sources may be used in parallel or series to selectively excite target isotopes/molecules to achieve separation of any number isotopes/molecules or tailoring of isotopes/compositions.

In act 230, the sample is then exposed to an electric field. The strength of the field is selected to cause field ionization of the first group of isotopic components, substantially without ionizing the second group of isotopic components. In various situations, field ionization induces a tunneling-like process that leads to escape of an excited electron from a metastable atom or molecule.

This selectivity may be facilitated by the metastable nature of the atoms (or molecules) in the first group. Continuing with the above example of mercury isotopes, act 220 may cause some or all of the Hg-196 atoms to be promoted into the 6s6p 3P2 metastable state or into the 6s6p 3P0 metastable state, which are 5.46 eV or 4.67 eV higher in energy, respectively, than the ground state. The other mercury atoms substantially all remain in the ground state. The ionization potential for mercury is 10.4 eV. Thus, the first group of components (Hg-196 atoms) is significantly closer to the ionization threshold than the second group (the non-promoted atoms). The electric field in act 230 can be tailored so that substantially only the first group of components is field ionized by the electric field. In various implementations, the exposure to the ionizing field in act 230 is conducted and concluded before the metastable components decay back to their ground state. In other implementations, the exposure in act 230 may have a duration substantially longer than the expected decay time of the metastable state(s).

In various implementations, the electric field in act 230 is a static field. In other implementations, the field may have a magnitude that is stepped and/or switched and/or rises and/or falls over time with frequency components in the range of 10̂−2 to 10̂3 Hertz. Aside from switching/stepping events, the temporal variation of the field in act 230 is generally slow compared to optical frequencies. In various implementations, the electric field is created by a positive voltage applied to the tips, so that positive ions created in act 230 are not accumulated onto the tips.

One approach to creating a sufficiently strong electric field is to use one or more sharp tips held at a high voltage. The electric field will be large in the vicinity around the sharp tips (electric field is more intense around conductive features with a small radius of curvature). Recent advances in carbon nanotube technology enables the construction of field tips useful for creating fields suitable for ionization of atoms or molecules in metastable electronic states. Examples include techniques that may also be used for the production of field emission points. See, e.g., Park-2012 and Park-2014, noted above. In various implementations, a carbon nanotube tip array may be constructed through a mask lithography processes, an ion beam lithography process, or using other manufacturing processes, or combinations thereof. In various implementations, a 2-D array of carbon nanotube tips has a repeated square pattern or other repeated pattern, or is a random pattern of tip positions. In various implementations, a 2-D array of carbon nanotube tips has inter-tip spacings of approximately 20 nm, approximately 50 nm, approximately 100 nm, approximately 200 nm, approximately 400 nm, approximately 1000 nm, approximately 1500 nm, or more. In various implementations, a carbon nanotube tip has a radius of curvature at the tip of approximately 1 nm, 2 nm, 3 nm, 4 nm, 5 nm, 8 nm, a few 10's of nm. For example, an effective radius of curvature at the tip (relevant to the generation of external fields around the tip) may be in the range of 0.5 nm to 2 nm, 2 nm to 5 nm, 5 nm to 10 nm, 10 nm to 20 nm, 20 nm to 100 nm.

In various implementations, a configuration geometry is used that causes the sample to closely approach the high-field regions around the sharp tips, to increase the yield of the field ionization process. In various implementations, the tip array may be densely packed so that each atom or molecule in the sample is near a field tip. In various implementations, the sample may be made compact or otherwise given a geometry so that most or all of the atoms or molecules in the sample are brought sufficiently close to a field tip to induce field ionization of a metastable atom or molecule.

In one example, the sample prepared in act 210 is prepared as a stationary vapor near or around the tips of a two-dimensional array of carbon nanotube tips. The tips are held at zero voltage during acts 210 and 220, but are energized to high voltage during act 230. Applying the high voltage to the tips in act 230 creates a high electric field around them, which may field ionize metastable atoms (or metastable molecules) in the sample that are sufficiently close to the tips. The duration of exposure of the sample to the ionizing field may be controlled by turning the tip voltage on and off.

In another example, the sample prepared in act 210 is prepared as a vapor atom beam that travels through optical pumping lasers in act 220, and then passes near high-voltage tips in act 230. The duration of exposure of the sample to the ionizing field may be controlled by adjusting the speed of the beam, adjusting the length of the tip array that is parallel to the beam, or adjusting other geometric factors of the beam-array interaction (e.g., angle of incidence, tip spacing), or combinations thereof.

After act 230, many or all of the atoms or molecules among the first group of isotopic components (e.g., Hg-196 atoms) will have been ionized by field ionization (e.g., into Hg+ions of Hg-196), since the field strength in act 230 was chosen to cause ionization of these metastable components. The atoms or molecules among the second group of isotopic components (e.g., other Hg atoms) will mostly still be neutral, since the field strength was chosen not to cause ionization of these ground-state components.

In act 240, the ions are spatially separated from the neutral atoms or molecules. This may be performed, for example, by applying an electric field to the sample. The electric field accelerates the ions without significantly accelerating the neutral components. Thus, after a short additional elapsed time, the first group of isotopic components will have effectively moved away from the second group of isotopic components. In various situations, the strength of the field used for separation in act 240 is significantly lower, e.g., by one or more orders of magnitude, than the field strength used for ionization in act 230. In various implementations, the exposure to the accelerating field in act 240 is initiated before the ions recombine with electrons and decay back to a neutral state after act 230.

In cases where the atoms interact with the surface metal, the electric field may repel the ions and inhibit recombination with electrons in the metal. In cases where a structure of sharp tips on the surface makes the field large enough that atoms are ionized prior to reaching the surface (also known as electric-field ionization), recombination is not as much of a concern.

In act 250, the desired components are collected or harvested. Since the first group of isotopic components and the second group of isotopic components are spatially separated in act 240, various means may be employed to capture one or both of these components. In various applications, the harvesting is performed while the ions from act 230 are still charged. In other applications, the harvesting is performed after the ions have recombined with electrons back into neutral atoms. For example, the first group of components may be impacted onto a cryogenic plate, or gathered in a tube, or passed through a collection aperture, or separated by a baffle, or optically trapped, or magnetically trapped, or magneto-optically trapped, or otherwise gathered while substantially excluding the second group of components. Alternatively, or in addition, the second group of components may be gathered while substantially excluding the first group of components.

In one example, after act 250 the first group of components has substantially only Hg+ions of Hg-196, and the spatially separate second group of components has neutral mercury atoms of other isotopes (possibly along with some neutral Hg-196). The Hg-196 ions are directed by an electric field onto a first cold metallic surface where they condense and may be gathered for further use. Alternatively, or in addition, the neutral mercury atoms may be gathered for further separation, tailoring or other use.

In various implementations, an array of ionizing field tips may be constructed by an etching process from a tungsten strip. In some applications, a desired isotope of mercury is accumulated on the tungsten strip and/or on tungsten tips, and is harvested by melting or evaporating the accumulated mercury.

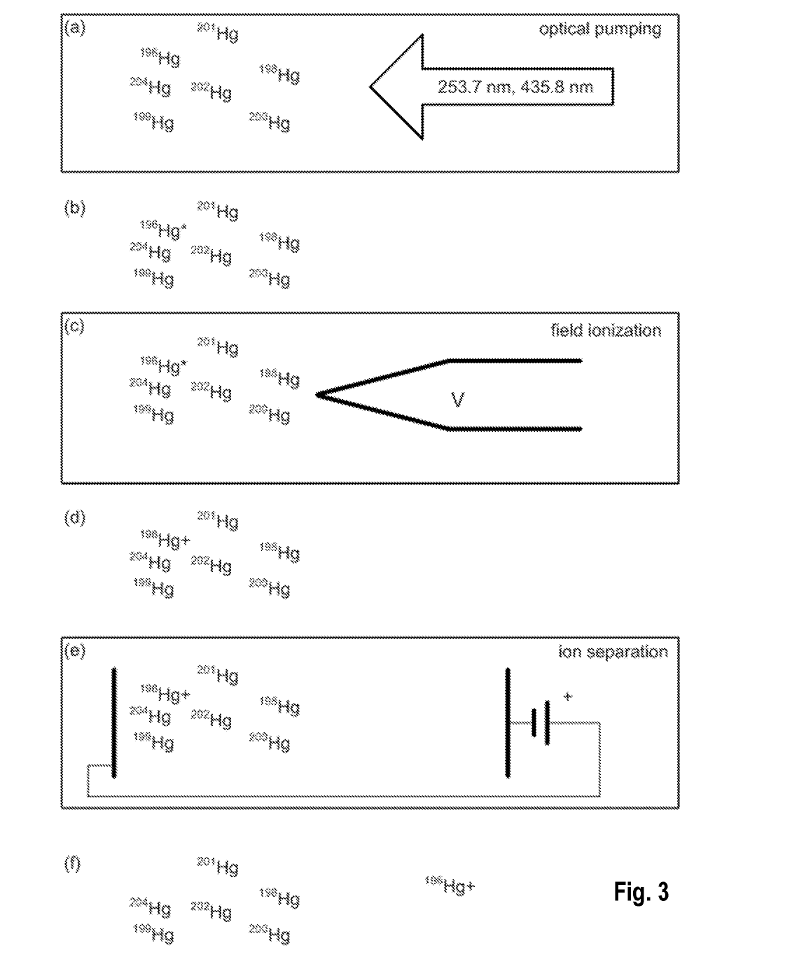

FIG. 3 illustrates a schematic of example stages in the ionization—and separation—of atoms using field ionization, in accordance with some embodiments.

FIG. 3 illustrates a schematic of an example sequence in which Hg-196 is spatially separated from a vapor of naturally occurring elemental mercury. In panel (a) of FIG. 3, a vapor cloud of mercury is exposed to light with two color components: 253.7 nm and 435.8 nm. At least one of the color components, the 253.7 nm color component, is narrow band and specifically tuned so that it is only absorbed by Hg-196; the other isotopes of mercury are effectively transparent to this color component. The vapor cloud includes mercury atoms of all seven naturally occurring mercury isotopes: Hg-196, Hg-198, Hg-199, Hg-200, Hg-201, Hg-202, and Hg-204.

Panel (b) of FIG. 3 shows the situation after the illumination from panel (a): the Hg-196 atoms have been excited to a metastable state (196Hg*) (* indicates the metastable state of an atom).

In panel (c) of FIG. 3, an ionizing electric field is applied to the vapor cloud. In this illustration, the electric field is generated at one or more sharp tips of a carbon nanotube bundle that is held at a high voltage.

Panel (d) of FIG. 3 shows the situation after the application of the field from panel (c): the atoms that were in the metastable state (196Hg*) have been ionized and now have an electric charge (196Hg+).

In panel (e) of FIG. 3, a separating electric field is applied to the vapor cloud. In this illustration, the electric field is generated by a pair of field plates around the cloud. An electric potential has been applied to the field plates. In general, the electric field applied in panel (c) is significantly larger than the electric field applied in panel (e). The separating electric field accelerates the ions in the cloud (196Hg+) without accelerating the neutral atoms.

Panel (f) of FIG. 3 shows the situation after some time has elapsed from the acceleration in panel (e): the accelerated atoms (196Hg+) have moved a sufficient distance so that they are spatially separated from the original cloud.

While FIG. 3 has been presented with an example that separates the mercury-196 isotope from a cloud of mercury atoms, more general separations are also contemplated. For example, the wavelengths used in panel (a) may be selected for addressing other mercury isotopes, or may include multiple colors to address multiple isotopes instead of just addressing one isotope. Similarly, this technique may be applied to other elements that have a suitable metastable state. Similarly, this technique may be applied to various compounds that have a suitable metastable state. Similarly, this technique may be applied to mixtures of elements, mixtures of compounds, or mixtures of elements and compounds that have one or more targetable components that can be isotopically selected for excitation to a suitable metastable state. As another example, the plates used for acceleration may have a non-planar geometry; in various applications, one of the plates in panel (e) may be integrated with (or may be) the field tip(s) from panel (c).

Moreover, FIG. 3 presents an example where a separation is performed on a stationary vapor cloud. Other configurations are also contemplated, such as a beam configuration in which a vapor of the original sample is projected past elements that act on the vapor.

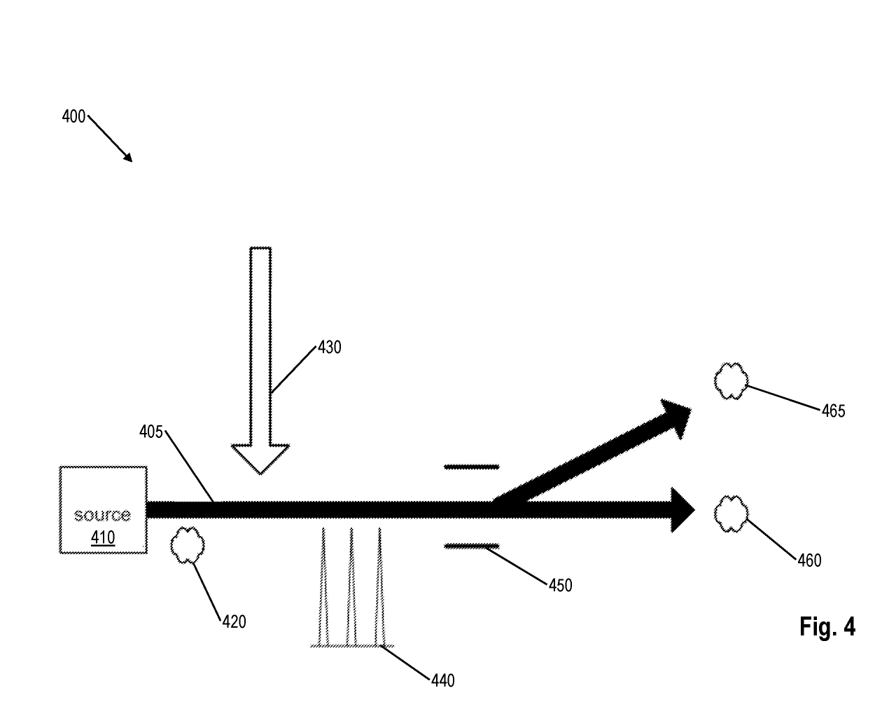

FIG. 4 illustrates an example of an apparatus configured to ionize—and separate—atoms using field ionization, in accordance with some embodiments.

FIG. 4 illustrates one example of an apparatus used for separating isotopic components from a vapor beam 405. Beam 405 is generated by a source 410. Beam 405 initially includes a moving vapor sample 420 that has two components to be separated. The vapor sample moves to a region where it is illuminated by light 430 that optically pumps atoms or molecules in the beam to an excited metastable state. Light 430 may include one or more wavelengths generated by sources such as lasers, diodes, flash lamps, gas discharges, or other sources. At least one of the wavelength components in light 430 is specifically tuned to one set of the isotopic components in the vapor sample. Thus, only some of the vapor sample, based on isotopic composition, is promoted to a metastable state.

The vapor sample then moves in beam 405 to the vicinity of one or more sharp tips 440 that generate an electric field. Tips 440 have a geometry and an applied voltage suitable for creating an electric field with a significant probability of ionizing the metastable components of the vapor sample, and a small or negligible probability of ionizing the ground-state components of the vapor sample. Tips 440 may include a single tip, multiple tips, uniform tips, a mixture of tips with different geometries, tips with the same applied voltage, tips with different voltages, a forest of tips arranged in a linear array, a planar array, 3-D array, regularly spaced arrays, randomly spaced arrays, or combinations thereof.

The vapor sample then moves in beam 405 to an electric field region depicted as being between two voltage plates 450. The electric field between plates 450 accelerates the ions generated when the vapor sample passed tips 440.

Because of the acceleration from plates 440, beam 405 splits into two beams. Continuing along the original trajectory is a vapor sample 460 that includes the left-behind components of the initial vapor sample 420. Another vapor sample 465 includes the components that were accelerated by the field between plates 465. After a sufficient propagation time, the transverse distance between samples 460 and 465 is sufficient to substantially or completely separate these samples. With appropriate tunings, fields, interaction times, and geometries, samples 460 and 465 may be sufficiently separated to have different isotopic compositions from the initial vapor sample 420 (and that have different isotopic compositions from each other).

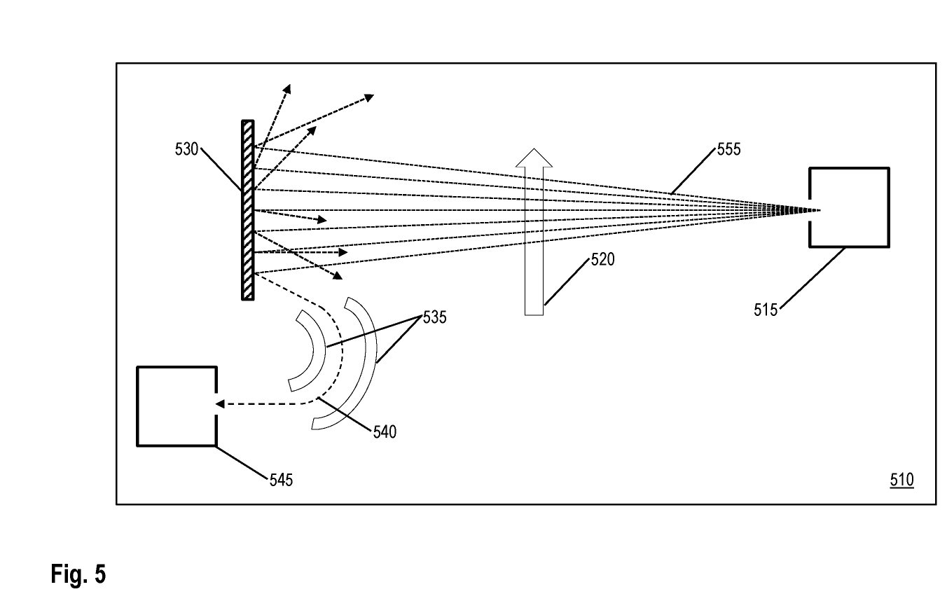

FIG. 5 illustrates an example of an apparatus configured to ionize—and separate—atoms using surface ionization, in accordance with some embodiments.

In some embodiments, apparatus 510 may be disposed within a vacuum chamber. A sample of atoms may be placed in source 515. In some embodiments, source 515 may be an oven heated to a certain temperature in order to create moving vapor atom beam 555. Atom beam 555 acquires a certain amount of kinetic energy from source 515 to move through the next stages in the process. In certain implementations, atom beam 555 may include two or more types of atoms. For example, atom beam 555 may include two or more isotopes of an element, either in atomic form or in molecular form bonded to other elements.

At the next stage, atom beam 555 is exposed to EM field 520. As the atoms move through the EM field 520, at least a subset of the atoms is promoted (with single or multiple transitions) to an excited metastable state. In some embodiments, EM field 520 may include one or more wavelengths generated by lasers, diodes, flash lamps, gas discharges, etc. In some embodiments, at least one of the wavelength components in EM field 520 may be specifically tuned to at least a subset of the atom sample (for example, to one or more isotopes in the sample). Thus, only a subset of the sample of atoms is promoted to a metastable state. The atoms that are promoted to the excited state will have a new excited ionization energy that is less than the original ionization energy of the atom in the ground state.

The sample of atoms then moves in the vicinity of the surface of ionizing material 530. Generally, atoms that are in close proximity to the surface of an ionizing material can be ionized if the ionization energy of the atom is less than the work function of the ionizing material. In some embodiments, various types of metals may be used as ionizing material 530 and may be chosen partially based on the work function of the metal.

In some embodiments, in order to inhibit/prevent the ionized atom from sticking to the surface of the ionizing material and consequently neutralizing (a processed sometimes referred to as Auger neutralization), the ionizing material may be biased with a high positive voltage to repel the positive ions, or the ionizing material may be heated to a high temperature. In some embodiments, the ionizing material may be kept at a high voltage and at a high temperature.

In some embodiments, ionizing material 530, such as the chosen metal, may be in the form of a thin extended ribbon. A floating current source may be connected to the ionizing material to generate heat and maintain the ribbon at an appropriate temperature. In addition, the ribbon may be biased at high positive voltage. In some embodiments, the voltage may be in the range of 6-10 kV. In some embodiments, the temperature and/or the voltage may be used to prevent ionized atoms from neutralizing through recombination with electrons.

In some embodiments, the physical distance between the EM field exposure stage and the ionization stage may depend partially on the decay time of the metastable state. The distance may be determined by considering factors such as the decay time, the kinetic energy of atom beam 555, etc.

For example, for calcium this metastable lifetime is several milliseconds, during which time the Ca atoms can travel a distance of more than 1 meter in the atom beam before decaying back to the ground state. In the case of Ytterbium, the lifetime is several microseconds, so the EM field exposure stage should be around 1 mm from the hot ribbon surface. These metastable lifetimes are sufficiently long periods to achieve high degrees of separation through application of the separation processes disclosed herein. In some cases, for a specific atom, there may be a choice of more than one metastable energy level. In such cases, a metastable energy level may be chosen to achieve a longer physical distance between the EM field stage and the ionization stage.

Once the desired atoms are ionized, they are transported to a collection region. This can readily be accomplished by using curved electrodes to avoid line-of-side between the hot ribbon and the collection region to guide the ions away to a separate region in the vacuum chamber where they can be collected. Absent a line of sight pathway from the hot ribbon, other isotopes are substantially excluded from the collection region.

In some embodiments, an ionizing material (such as a metal) may be chosen based at least upon the work function of that ionizing material. For example, a desirable value for the work function may be less than the atom's ground state ionization energy and greater than the ionization energy at the excited state. As such, in the proximity of ionizing material 530, there is a high probability that the atoms in the ground state do not ionize, while the atoms in the excited states do ionize.

In the case of Hg, the ionization energy from the ground state is 10.4375 eV. The ionization energy from one of the metastable states is approximately 4.85 eV. A ground state Hg atom would not be ionized by impact on any metal surface since the work function is much smaller than the ionization energy. However, many materials have a work function that is higher than 4.85 eV. For example, Iridium has a work function that is higher than 5 eV. As such, the ground state of Hg would have a low probability of ionization near the Iridium surface, but the metastable state of Hg would have a high probability of ionization near the Iridium surface.

Plates 535 are biased such that an electric field forms between the plates. As such, the plates are configured to bend/accelerate atoms that have been ionized and not affect atoms that have remained in the ground state. It should be noted that other methods may be used to separate the ions from the neutral atoms, such as a magnetic field, for example.

Any ions that follow path 540 may then be collected in container 545 or other suitable collector. Through the use of appropriate tunings, fields, interaction times, and geometries, the ions may thus be efficiently separated from the neutral atoms.

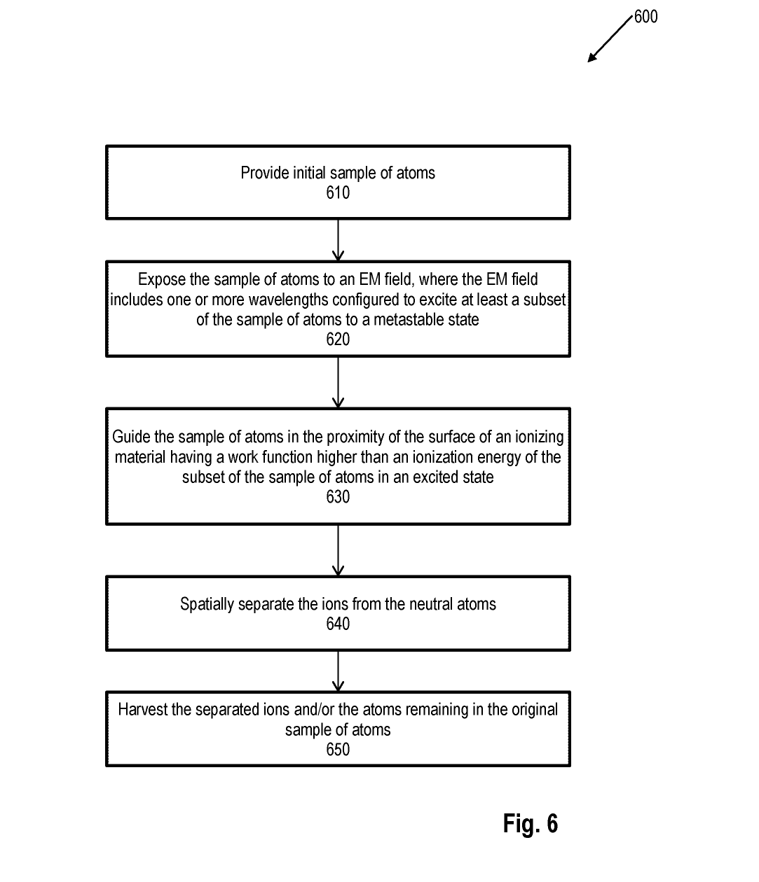

FIG. 6 illustrates a flow diagram of an example procedure for separating isotopes using surface ionization, in accordance with some embodiments.

FIG. 6 shows an example of a procedure 600 for separating different atoms from an initial sample of atoms. Procedure 600 may be used in various situations to separate a sample of different type of atoms into two or more samples. It should be noted that the initial sample of atoms may include atoms that are attached to other atoms in molecular compounds.

In act 610, an initial sample of atoms is provided. In various circumstances, the initial sample of atoms may be a sample containing two or more isotopes of an element. For example, the sample may be a substantially chemically pure sample, such as a sample of elemental mercury or elemental ytterbium. In other situations, the initial sample may have some contamination, or may be a mixture of atoms of different elements.

In various embodiments, the initial sample may be isolated in a vacuum chamber and vaporized, using an oven, for example. Depending on the implementation, the initial sample may be prepared as a thermal vapor, or may be optically trapped, magnetically trapped, or magneto-optically trapped, or may be projected in a vapor beam.

In act 620, the sample is exposed to an EM field, such as a light field. The EM field may include one or more wavelengths that may be specifically chosen to distinguish among different types of atoms in the sample. With this wavelength-based distinction, procedure 600 may be used to spatially separate a subset of atoms from the rest of the sample.

The wavelength(s) of the EM field may be chosen so that a subset of the atoms has a high probability of absorbing the field in act 620 and being promoted into a metastable state, while the remaining atoms have a low probability of absorbing the field or a low probability of being promoted to a metastable state.

In addition, the atomic beam divergence in the transverse direction (the direction perpendicular to the direction of the atom beam and parallel to the EM field, in some embodiments) may be limited such that the Doppler width of the atoms in that direction is substantially less than the isotope shift. As such, only the desired isotope may be excited to a metastable state.

In act 630, the sample is guided in proximity to the surface of an ionizing material. The ionizing material, such as a metal, for example, may be chosen based on the ionizing material's work function. For example, a work function value may be desired that is higher than the ionization energy of the atoms in the excited state and lower than the ionization energy of the atoms in the ground state. As such, there is a high probability that the atoms in the excited states become ionized, and a low probability that the atoms in the ground state become ionized.

In act 640, the ions are spatially separated from the neutral atoms or molecules. This may be performed, for example, by applying an electric field to the sample of atoms. The electric field accelerates the ions without significantly accelerating the neutral components. Thus, after a short additional elapsed time, a subset of the atoms will have moved away from the rest of the atoms in the sample. In various implementations, the exposure to the accelerating field in act 640 is initiated before the ions recombine with electrons and decay back to a neutral state after act 630.

In act 650, the separated components may be collected or harvested. Various means may be employed to capture one or both components. In various applications, the harvesting is performed while the ions from act 630 are still charged. In other applications, the harvesting is performed after the ions have recombined with electrons back into neutral atoms.

One or more embodiments are disclosed herein. It should be noted that these and any other embodiments are exemplary and are intended to be illustrative rather than limiting. While what is disclosed is widely applicable to various types of systems, a skilled person will recognize that it is impossible to include all of the possible embodiments and contexts in this disclosure. Upon reading this disclosure, many alternative embodiments will be apparent to persons of ordinary skill in the art.

Those of skill will appreciate that the various illustrative logical blocks, modules, circuits, and steps described in connection with the embodiments disclosed herein may be implemented as hardware, firmware, software, or combinations of those. To illustrate clearly this interchangeability of hardware, firmware, and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

1. A method comprising:
exposing a sample of atoms to an electromagnetic (EM) field, wherein the EM field comprises one or more frequencies, wherein the EM field is configured to promote at least a subset of the sample of atoms to one or more excited states based at least upon the one or more frequencies, wherein the one or more excited states are metastable states; and
ionizing the subset of the sample of atoms based at least upon the subset of the sample of atoms being at the one or more excited states.

2. The method of claim 1, wherein the sample of atoms comprises two or more isotopes of an element, wherein at least one of the isotopes is promoted to the one or more excited states based at least upon the EM field being selective to excite the at least one of the isotopes, wherein the one or more excited states are low-lying states.

3. The method of claim 2, wherein the ionizing comprises ionizing the at least one of the isotopes based at least upon the at least one of the isotopes being at the one or more excited states.

4. The method of claim 3, separating the at least one of the isotopes from the two or more isotopes based at least upon the ionizing of the at least one of the isotopes.

5. The method of claim 1, wherein the ionizing comprises applying an ionizing electric field to the sample of atoms.

6. The method of claim 1, wherein the ionizing comprises guiding the subset of the sample of atoms in the proximity of a surface of an ionizing material, wherein the ionizing is based at least upon an ionizing energy of the subset of the sample of atoms in the one or more excited states being lower than a work function of the ionizing material.

7. The method of claim 6, further comprising inhibiting neutralization of the ionized subset of the sample of atoms at the surface of the ionizing material based upon at least one of:
raising the temperature of the ionizing material; and
applying a positive voltage to the ionizing material.

8. A system comprising:
an electromagnetic (EM) field source configured to generate an EM field and to expose, to the EM field, a sample of atoms, wherein the EM field comprises one or more frequencies, wherein the EM field is configured to promote at least a subset of the sample of atoms to one or more excited states based at least upon the one or more frequencies, wherein the one or more excited states are metastable states; and
an ionizer configured to ionize the subset of the sample of atoms based at least upon the subset of the sample of atoms being at the one or more excited states.

9. The system of claim 8, wherein the sample of atoms comprises two or more isotopes of an element, wherein at least one of the isotopes is promoted to the one or more excited states based at least upon the EM field being selective to excite the at least one of the isotopes, wherein the one or more excited states are low-lying states.

10. The system of claim 9, wherein the ionizer is configured to ionize the at least one of the isotopes based at least upon the at least one of the isotopes being at the one or more excited states.

11. The system of claim 10, further comprising a separator configured to physically separate the at least one of the isotopes from the two or more isotopes based at least upon the ionizing of the at least one of the isotopes.

12. The system of claim 8, wherein the ionizer is configured to apply an ionizing electric field to the sample of atoms.

13. The system of claim 12, wherein the ionizer comprises one or more carbon nanotube tips configured to generate the electric field near the one or more carbon nanotube tips.

14. The system of claim 8, wherein the ionizer is configured to guide the subset of the sample of atoms adjacent a surface of an ionizing material, wherein the ionizing is based at least on an ionization energy of the subset of the sample of atoms in the one or more excited states being lower than a work function of the ionizing material.

15. The system of claim 14, wherein neutralization of the ionized subset of the sample of atoms at the surface of the ionizing material is inhibited based upon at least one of:
maintaining the ionizing material at a high temperature; and
maintaining the ionizing material at a high positive voltage.

16. A system comprising:
an electromagnetic (EM) field source configured to generate an EM field and to expose, to the EM field, two or more isotopes, wherein the EM field comprises one or more frequencies, wherein the EM field is configured to promote at least a subset of the two or more isotopes to one or more excited states based at least upon the one or more frequencies, wherein the one or more excited states are metastable states; and
an ionizer configured to ionize the subset of the two or more isotopes based at least upon the subset of the two or more isotopes being at the one or more excited states.

17. The system of claim 16, further comprising a separator configured to physically separate the subset of the two or more isotopes from a remainder of the two or more isotopes based at least upon the ionizing of the subset of the two or more isotopes.

18. The system of claim 16, wherein the ionizer is configured to apply an ionizing electric field to the two or more isotopes.

19. The system of claim 16, wherein the ionizer is configured to guide the at least one isotope adjacent a surface of an ionizing material, wherein the ionizing is based at least on an ionization energy of the subset of the two or more isotopes in the one or more excited states being lower than a work function of the ionizing material.

20. The system of claim 16, wherein the one or more excited states are low-lying states.
